(19) United States
(12) Patent Application Publication
(10) Pub. No.: US 2026/0347636 A1
(43) Pub. Date: Nov. 5, 2026

(54) CARBOXYMETHYL CELLULOSE, COMPOSITIONS AND USE THEREOF IN BATTERIES

(71) Applicant: DANISCO USA INC., New Century, KS (US)

(72) Inventors: Roland Bayer, Bomlitz (DE); Oliver Petermann, Bomlitz (DE)

(21) Appl. No.: 19/140,077

(22) PCT Filed: Jan. 16, 2024
(86) PCT No.: PCT/US2024/011617

§ 371 Date: Jun. 17, 2025

(30) Foreign Application Priority Data
Jan. 16, 2023 (EP) 23151801.0

(51) Int. Cl. C09D 101/28; C08B 11/12; C08K 3/04; C08K 3/34; C08L 1/28

(52) U.S. Cl. CPC C09D 101/286; C08B 11/12; C08K 3/04; C08K 3/041; C08K 3/042; C08K 3/34; C08L 1/286

(57) ABSTRACT

The present invention is directed to a carboxymethyl cellulose (CMC), compositions comprising CMC, their methods of preparation and uses thereof in for example batteries.

### FIELD OF THE INVENTION

The present invention is directed to a carboxymethyl cellulose (CMC), compositions comprising CMC, their methods of preparation and uses thereof in for example batteries.

### BACKGROUND

CMCs are used in a wide variety of technical fields. Areas which benefit from the thickening and gel-forming properties of CMC are, for example, oil industry (e.g., in drilling fluids), food industry, pharmaceutical industry, paper industry, electrical and electronic industry, textile industry and construction industry.

The significant growth of electrical vehicles and portable electronic devices has led to an increase in the demand for rechargeable batteries, especially the various types of lithium-ion batteries.

CMC is often used as a dispersant and as a thickener in the manufacturing of batteries such as anode coatings for Li-ion batteries. Beside CMC also graphite, carbon black and SBR (styrene-butadiene-rubber)-latex may be used in this type of formulation. Usually, all ingredients are being mixed under high shear and lead to a slightly viscous slurry. This slurry is being used for the coating of the metallic anode, normally a copper or aluminum film. The required size of the coated anode normally is punched/stamped out of the coated copper film to manufacture a pouch cell. Due to the brittle nature and the poor adhesion of the coating on the copper electrode it might happen that small parts of the coating fall apart and remain on the electrode. After automatic assembling of the battery cell those small particles can lead to off-spec production. This leads to the need to get an improved adhesion of the coating on the metallic electrode.

Also, it is a well-known problem that a secondary battery based on Li-ion technology can be loaded only limited times. With many charging and discharging cycles the battery reduces its capacity. This first, makes charging more frequently required and furthermore the discharge capacity is being reduced with every charging cycle. For that reason, the speed of decrease of the discharge capacity is a well-established quality parameter for batteries. Usually, the number of charging cycles are mentioned after which 20% of the initial discharge capacity is lost. Thus, there still is a need for batteries having improved performances regarding charge/discharge characteristics.

CMC with a low degree of substitution (DS) has been suggested for use in nonaqueous electrolyte secondary battery. CMC with a degree of substitution (DS) lower than 0.4 is known to be insoluble in water according to literature (James N. BeMiller, in Carbohydrate Chemistry for Food Scientists (Third Edition), 2019, 223-240). Preparation of CMCs having a low degree of substitution (DS) by alkalization with sodium hydroxide (NaOH) or potassium hydroxide (KOH) and subsequent carboxymethylation with monochloroacetic acid is described in numerous documents, e.g. WO 2011/120533. US20220020993A1 describes carboxymethylcellulose or a salt thereof for a nonaqueous electrolyte secondary battery with a DS of 0.5 to 1.5. US20210214466A1 describes CMC with a DS 0.50 or less and a degree of crystallization of cellulose I type of 50% or more.

Ronald Gordon, Raquel Orias and Norbert Willenbacher have investigated CMC's with a DS from 0.7-1.2. (Effect of carboxymethyl cellulose on the flow behavior of lithium-ion battery anode slurries and the electrical as well as mechanical properties of corresponding dry layers; J Mater Sci (2020) 55:15867-15881). Lee tested two different DS on graphite absorption and battery performance: a lower DS value (0.7) resulted in greater uptake of CMC on graphite compared with a higher DS value (1.28). The greater adsorption for DS=0.7 correlates with a higher adhesion strength with a copper substrate, and a greater retention of discharge capacity after cycling (Jin-Hyon Lee et al 2006 Meet. Abstr. MA2005-01 1358 and Jin-Hyon Lee et al., Effect of Carboxymethyl Cellulose on Aqueous Processing of Natural Graphite Negative Electrodes and their Electrochemical Performance for Lithium Batteries; The Electrochemical Society, 152 (9) A1763-A1769 (2005).

However, there still is a need for CMC for batteries having improved performance such as charge/discharge characteristics and high durability.

### OBJECT OF INVENTION

In order to overcome the current challenges of providing an improved adhesion of coatings based on CMC and improved charge/discharge characteristics in batteries, the inventors have found that when using carboxymethylcellulose (CMC) having a degree of substitution (DS) equal to or below 0.6 and having a turbidity equal to or below 10 NTU, measured as a 2 weight % aqueous solution according to USEPA method 180.1, a very homogenous electrode coating may be obtained resulting in low differences between several individual cells as well as in a low “noise” (scattering of the specific discharge capacity of an individual cell as a function of the cycle), and improvement in the specific discharge capacity as a function of the number of charging/discharging cycles.

This is surprising and not expected to a skilled person in the art.

It is therefore an object of the present invention to provide a CMC with a low degree of substitution (DS) and a turbidity equal to or below 10 NTU, and compositions and uses thereof.

It is further an object of the present invention to provide the use of the present CMCs as a coating agent for a battery electrode, a battery electrode coated with such a coating agent and a battery comprising such an electrode. It is further an object of the present invention to provide a process for preparing a composition as disclosed herein.

### SUMMARY OF THE INVENTION

Disclosed herein is a composition comprising carboxymethylcellulose (CMC), wherein the carboxymethylcellulose (CMC) has a degree of substitution (DS) equal to or below 0.6 and has a turbidity equal to or below 10 NTU, measured as a 2 weight % aqueous solution according to USEPA method 180.1.

Disclosed herein is also carboxymethylcellulose (CMC) having a degree of substitution (DS) equal to or below 0.6 and having a turbidity equal to or below 10 NTU, measured as a 2 weight % aqueous solution according to USEPA method 180.1.

Disclosed herein is furthermore the use of a composition as a coating agent for a battery electrode such as a lithium-ion battery electrode or a sodium-ion battery electrode, wherein said composition comprises carboxymethylcellulose (CMC) having a degree of substitution (DS) equal to or below 0.6 and has a turbidity equal to or below 10 NTU, measured as a 2 weight % aqueous solution according to USEPA method 180.1.

Furthermore, disclosed herein is a battery electrode, wherein the electrode is coated with a composition, wherein said composition comprises carboxymethylcellulose (CMC) having a degree of substitution (DS) equal to or below 0.6 and has a turbidity equal to or below 10 NTU, measured as a 2 weight % aqueous solution according to USEPA method 180.1, and a battery comprising such a battery electrode.

Disclosed herein is also a process of preparing a composition comprising carboxymethylcellulose (CMC), wherein the carboxymethylcellulose (CMC) has a degree of substitution (DS) equal to or below 0.6 and has a turbidity equal to or below 10 NTU, measured as a 2 weight % aqueous solution according to USEPA method 180.1, said method comprising the steps of:
a. Preparing a homogenous dry mixture of graphite, carbon black and optionally silicone
b. Mixing a solution of carboxymethylcellulose (CMC) with 50% of the homogeneous mixture of graphite, carbon black and optionally silicone prepared in step a),
c. Adding water to the mixture obtained in step b),
d. Adding the remaining 50% of the dry mixture of graphite, carbon black and optionally silicone prepared in step a) to the mixture obtained in step c),
e. Adding water to the mixture obtained in step d),
f. Adding polymer latex to the mixture obtained in step e).

The presence of graphite, carbon black in the composition is optional.

The composition according to the present invention may also contain hard carbon.

Silicon can be replaced by silicon-based material like silicon suboxide (SiO) and silicon carbide (SiC).

### DESCRIPTION OF DRAWINGS

FIG. 1 contains the curves which were evaluated for the determination of the slopes of the indicated CMC's (see comparative example 1).

FIG. 2 contains the mean value of discharge capacity as a function of the cycle number of the indicated CMC's (see comparative example 1).

### DETAILED DESCRIPTION OF INVENTION

The detailed aspects of this invention are set out below. Some of the detailed aspects are discussed in separate sections. This is for ease of reference and is in no way limiting. All the embodiments described below are equally applicable to all aspects of the present invention unless the context specifically dictates otherwise.

The term “CMC” or “carboxymethyl cellulose” as used herein encompasses carboxymethyl cellulose or salts thereof, such as cellulose substituted with groups of the formula-CH₂CO₂A, wherein A is hydrogen or a monovalent cation, such as K⁺ or preferably Na⁺. Examples of the salt of carboxymethyl cellulose may include metal salts such as sodium carboxymethyl cellulose salt.

“Active material” and like terms mean, as used in the context of a lithium-ion battery, a substance that is either the source of lithium ions or that can receive and accept lithium ions. In the context of the cathode of a lithium-ion cell, the active material is the source of the lithium ions, e.g., lithium cobalt oxide, lithium manganese oxide, etc. In the context of the anode of a lithium-ion cell, the active material is the receptor of the lithium-ions, e.g., graphite. The active materials are typically in the form of very small particles having a diameter from 100 nanometres to 100 micrometres.

“Anode” and like terms, as used in the context of a lithium-ion battery, mean the negative electrode in the discharge cycle. The anode is the electrode where oxidation takes place within the battery during discharge, i.e., electrons are freed and flow out of the battery.

“Battery” and like terms mean a collection of cells or cell assemblies which are ready for use. A battery typically contains an appropriate housing, electrical interconnections, and, possibly, electronics to control and protect the cells from failure, e.g., fire, thermal runaway, explosion, loss of charge, etc. The simplest battery is a single cell. Batteries can be primary, i.e., non-rechargeable, and secondary, i.e., rechargeable.

“Binder polymers” and like terms mean, as used in the context of a lithium-ion battery, a polymer that holds the active material particles within an electrode of a lithium-ion battery together to maintain a strong connection between the electrode and the contacts. Binder polymers are normally inert to the substances in which they are in contact within the lithium-ion battery during discharging, charging and storage.

“Cathode” and like terms, as used in the context of a lithium-ion battery, mean the positive electrode in the discharge cycle. The lithium in a lithium-ion battery is in the cathode. The cathode is the electrode where reduction takes place within the battery during discharge.

“Cell” and like terms mean a basic electrochemical unit that contains the electrodes, separator, and electrolyte.

“Conductive agent” and like terms mean, as used in the context of a lithium-ion battery, a substance that promotes the flow of ions between the electrodes of a cell. Carbon-based compounds and materials, e.g., acetylene black, carbon nanotubes, carbon-based polymers, and the like, are typical conductive agents used in lithium-ion batteries.

“Electrolyte” and like terms mean, as used in the context of a lithium-ion battery, a substance that carries positively charged lithium ions from the anode to the cathode, and vice versa, through a separator.

“Lithium-ion battery” and like terms mean a rechargeable (i.e., a secondary) battery in which lithium ions move from the negative electrode to the positive electrode during discharge and back when charging. Lithium-ion batteries use an intercalated lithium compound as one electrode material as opposed to the metallic lithium used in a non-rechargeable lithium battery (also known as a primary battery). The electrolyte, which allows for ionic movement, and the two electrodes are the constituent components of a lithium-ion battery cell.

“Separator” and like terms mean, as used in the context of a lithium-ion battery, a thin, porous membrane that physically separates the anode and cathode. The primary function of the separator is to prevent physical contact between the anode and cathode, while facilitating lithium-ion transport within the cell. Separators are typically a simple plastic film, e.g., polyethylene or polypropylene, or a ceramic, with a pore size designed to allow lithium-ion transit.

“Solvent” and like terms mean a substance that is capable of dissolving another substance (i.e., a solute) to form an essentially uniformly dispersed mixture (i.e., solution) at the molecular or ionic size level.

The process of preparing carboxymethyl cellulose as disclosed herein comprises reacting non-regenerated cellulose with an alkalization agent and monohaloacetic acid or a salt thereof, preferably the sodium salt.

As used herein, the term “regenerated cellulose” refers to cellulose that has been prepared by regeneration (i.e., return to solid form) from a solution that includes dissolved cellulose fibers. The term “non-regenerated cellulose” refers to cellulose that has not gone through a process of dissolving cellulose, typically cellulose fibers, in a solvent, and then regenerating it from that solution, i.e., recovering cellulose in solid form. In particular “non-regenerated cellulose” refers to cellulose that has not been recovered from a cellulose xanthogenate solution or a cellulose/cupramonium solution or a solution of cellulose in N-methylmorpholin-N-oxide.

The alkalizing agent is preferably NaOH, KOH or a mixture thereof. In one embodiment of the invention NaOH is used as the alkalization agent. In another embodiment KOH is used as the alkalization agent. In the latter case remaining K⁺ ions in the produced CMC are preferably exchanged by Na⁺ ions in a subsequent step.

The monohaloacetic acid can be used as free acid or in its salt form. Preferably, monochloroacetic acid or its salt is used in the inventive process, including all preferred embodiments described in the following.

According to the present invention, it is important to observe the molar ratios of each of the above-described components during preparation of the CMC.

The alkalizing agent, including the preferred alkalizing agents described above, is used in an amount from 2.5 to 10 mol, preferably in an amount from 3.1 to 10 mol, more preferably in an amount from 3.5 to 8 mol, most preferably in an amount from 4 to 7 mol; based on 1 mol of anhydroglucose unit of the cellulose.

The monohaloacetic acid, preferably monochloroacetic acid, is used in an amount of from 0.2 to 2 mol of monohaloacetic acid or a salt thereof, preferably in an amount from 0.3 to 1.5 mol, more preferably in an amount from 0.4 to 1 mol, more preferably in an amount from 0.5 to 0.8 mol; each based on 1 mol of anhydroglucose unit of the cellulose. These preferred amounts of monohaloacetic acid are preferably used in combination with the preferred amounts of alkalizing agent indicated above.

The ratio alkalizing agent/monohaloacetic acid is preferably between 2.4-20, more preferably between 2.6-20; most preferably between 2.8-20. The ratio alkalizing agent/monohaloacetic acid is further preferably between 3.0-15; more preferably between 3.5-14 and most preferably between 4.0-13.

Water is used in the alkalizing step (a) in an amount of preferably less than 15 moles of water, based on 1 mol of anhydroglucose unit of the cellulose. In another embodiment, water is used in the alkalizing step (a) in an amount of preferably more than 15 moles of water, based on 1 mol of anhydroglucose unit of the cellulose. In another embodiment, water is used in the alkalizing step (a) in an amount of preferably from 10 to 14.95 mol, more preferably in an amount from 12 to 14.92, most preferably in an amount from 14 to 14.9 mol, based on 1 mol of anhydroglucose unit of the cellulose. In another embodiment, water is used in the alkalizing step (a) in an amount of preferably from 15 to 45 mol, more preferably in an amount from 20 to 45, most preferably in an amount from 30 to 45 mol, based on 1 mol of anhydroglucose unit of the cellulose.

These preferred amounts of water are preferably used in combination with the preferred amounts of alkalizing agent and monohaloacetic acid indicated above. Isopropyl alcohol is generally used in the alkalizing step (a) in an amount of from 100 to 10 mol, preferably from 80 to 20 mol, more preferably from 60 to 30 mol, and most preferably from 55 to 32 mol, each based on 1 mol of anhydroglucose unit of the cellulose. These preferred amounts of isopropyl alcohol are preferably used in combination with the preferred amounts of alkalizing agent, monohaloacetic acid and water indicated above.

In a preferred embodiment of the invention non-regenerated cellulose is reacted with the alkalization agent in the presence of water and isopropyl alcohol and an additional amount of methanol. Methanol, if present, is preferably used in the alkalizing step (a) in an amount of from 10 to 1 mol, more preferably from 9 to 2 mol, even more preferably from 8 to 3 mol, and most preferably from 7 to 4 mol, each based on 1 mol of anhydroglucose unit of the cellulose. These preferred amounts of methanol are preferably used in combination with the preferred amounts of alkalizing agent, monohaloacetic acid, water, and isopropyl alcohol indicated above.

It is understood that the solvents (i.e. water, isopropyl alcohol and optionally methanol) introduced in the alkalizing step (a) are typically not removed deliberately before or during reaction of the alkalized cellulose with the monohaloacetic acid and thus said solvents also constitute the reaction medium of step (b). However, it is noted that the amounts of water, isopropyl alcohol and optional methanol specified above only refer to the amounts present during alkalization in step (b) and do not include any additional amounts of said solvents that may optionally be added later in the process. e.g. during reaction with monohaloacetic acid in step (b).

In some embodiments, including embodiments using the preferred amounts of components as indicated above, the alkalizing agent and the monohaloacetic acid are used in a molar ratio of from 20 to 2.5, more preferably from 15 to 2.8, even more preferably from 12 to 3, and most preferably of about 11 to 4.

The CMC's used in the composition disclosed herein has a degree of substitution (DS) equal to or below 0.6 and has a turbidity equal to or below 10 NTU, measured as a 2 weight % aqueous solution according to USEPA method 180.1.

In some embodiments, the carboxymethylcellulose (CMC) disclosed herein has a turbidity in the range of 1-10 NTU, more preferably in the range of 1.5-8 NTU, more preferably in the range of 2-6 NTU, more preferably in the range of 2-5 NTU, most preferably in the range of 2-4 NTU, measured as a 2 weight % aqueous solution according to USEPA method 180.1.

In some embodiments, the carboxymethylcellulose (CMC) disclosed herein has a turbidity equal to or below 8 NTU, preferably equal to or below 7 NTU, more preferably equal to or below 6 NTU, more preferably equal to or below 5 NTU, most preferably equal to or below 4 NTU, measured as a 2 weight % aqueous solution according to USEPA method 180.1.

In some further embodiments, the carboxymethylcellulose (CMC) disclosed herein has a degree of substitution (DS) equal to or below 0.55, more preferably equal to or below 0.5, more preferably equal to or below 0.45, most preferably equal to or below 0.4.

The degree of substitution (DS) is the average number of OH groups that have been substituted in one anhydroglucose unit. It is determined according to ASTM D 1439-03 “Standard Test Methods for Sodium Carboxymethylcellulose; Degree of Etherification, Test Method B: Nonaqueous Titration”. The treatment of a solid sample of the CMC with glacial acetic acid at boiling temperature releases an acetate ion quantity equivalent to the sodium carboxymethyl groups. These acetate ions can be titrated as a strong base in anhydrous acetic acid using a perchloric acid standard solution. The titration end point is determined potentiometrically. Other alkaline salts of carboxylic acids (e. g. sodium glycolate and di-sodium diglycolate) behave similarly and are co-titrated.

In one aspect of the present invention the novel CMCs, including those having preferred degrees of substitution as described above, typically have a viscosity, measured as a 2 weight % aqueous solution as described below, of at least 100 mPa·s, preferably at least 440 mPa·s, more preferably at least 600 mPa·s, and most preferably of at least 800 mPa·s. The viscosity is generally up to 40,000 mPa·s, preferably up to 30,000 mPa·s, preferably up to 25,000 mPa·s, more preferably up to 20,000 mPa·s, measured as a 1 weight % aqueous solution as described below.

In order to determine the viscosity, a 2% solution is prepared as follows (total amount of solution 300 g). 294 g deionized water (water in CMC is subtracted) is placed in 500 ml screw cap bottle which is being thermostated at 25 °C. 6 g (dry weight) of the CMC is then stirred in evenly at a rotating speed of approx. 1300 to prepare a solution. After that the solution is stirred at a constant rotating speed (approx. 1000-1500 rpm) and at a temperature of 25 °C for 1 h and 30 min. Then the stirrer is switched off, the solution is kept at 25 °C without stirring for 30 minutes before the viscosity is determined. The viscosity of the solution was measured using a Brookfield LVT viscometer, 30 rpm, 25° with spindle 1 for examples F, G and H; spindle 2 for example B; spindle 3 for examples A, C, D, E, 704 and comparative examples; spindle 4 for example 720

Not only the aqueous solutions of the present CMCs are highly viscous, but it is furthermore very surprising that the clarity of the aqueous CMC solutions is good, i.e., much better than what it would have been expected based on the relatively low degree of substitution.

Preferably, 2 weight % aqueous solutions of the novel CMCs according to the present invention, including those preferred CMCs described above, have transmission values of from 100 to 5%, more preferably from 100 to 5%, even more preferably from 100 to 8%, measured as indicated below.

2 weight % aqueous solutions of CMC are prepared as described above in connection with the viscosity analysis with additional rolling on a roller device for 24 h. The transmission and the turbidity are analyzed with the Turbidimeter 2100AN using a tungsten filament lamp emitting light of a wavelength of 300 to 1000 nm (Hach Company, Loveland, Colorado, USA). The transmission is the photometric analysis of the transmitted light through a sample cell (diameter: 24 mm) at a given wavelength (here 610 nm). It is given in % transmitted light. The system is calibrated against water (100% transmission). The result is the average of eight measurements. The turbidity is the analysis of the scattered light through a sample cell (diameter: 24 mm) and is given in NTUs (nephelometric turbidity units) according to USEPA method 180.1. The analysis is performed against a formazin standard ranging from <0.1 NTU to 7500 NTU (StablCal™, catalogue number 2659505). A USEPA method 180.1 filter module (catalogue number 3031200, 400 to 600 nm) is used. The result is the average of ten measurements.

The type of non-regenerated cellulose to be used for preparing the CMC is not essential for the present invention and is governed by the intended end-use of the CMC. Conventional non-regenerated starting materials are natural cellulose, such as cotton linters and wood pulp, e.g. hard wood or soft wood pulp. Typically, cotton linters or wood pulp are used, depending on the desired application of the CMC. Pulps according to present invention have a limiting viscosity number measured according to ISO 5351:2010 from 50 to 300 mL/g, preferably from 1000 to 3000 mL/g and more preferably from 300 to 1000 mL/g.

The CMCs derived from wood pulp are very useful due to their superior viscosity and gel forming properties. Although wood pulp is a preferred raw material in the present process for economic reasons, it is, of course, also possible to employ cotton linters if a CMC of extraordinarily high viscosity is desired for some reasons.

The essential steps of the preparation method of carboxymethyl cellulose are alkalizing the cellulose by reaction with the alkalizing agent (alkalizing step (a)) and adding monohaloacetic acid to cause etherification of the alkali cellulose (carboxymethylation step (b)).

The cellulose is first alkalized in the presence of water and isopropyl alcohol and optionally methanol in the alkalizing step (a) and then the monohaloacetic acid is added in the carboxymethylation step. In the alkalizing step, the single components (e.g. cellulose, water, isopropyl alcohol, alkalizing agent, and optionally methanol) can be added in arbitrary order. However, it is preferred that the cellulose is combined with water, isopropyl alcohol, and optionally methanol in a first step and the alkalizing agent is then added in a subsequent step. If methanol is used, it can be added to the reaction mixture before, at the same time or shortly after the addition of the monohaloacetic acid, but preferably it is added at the same time as water and/or isopropyl alcohol, either separately or as a mixture with water and/or isopropyl alcohol.

There are various options how to contact the cellulose with the alkalizing agent. Preferably, cellulose powder is used as starting material. Typically, the cellulose powder is suspended (slurried) in the solvent/water mixture comprising water, isopropyl alcohol and optionally methanol before the alkalizing agent is added as a solid or as an aqueous solution. However, the total amount of water used in the alkalizing step should be in an amount of less than 15 moles of water, based on 1 mol of anhydroglucose unit of the cellulose. In another embodiment, water is in an amount of more than 15 moles of water, based on 1 mol of anhydroglucose unit of the cellulose. In another embodiment, water is in an amount of from 10 to 14.95 mol, more preferably in an amount from 12 to 14.92, most preferably in an amount from 14 to 14.9 mol, based on 1 mol of anhydroglucose unit of the cellulose. In another embodiment, water is in an amount of from 15 to 45 mol, more preferably in an amount from 20 to 45, most preferably in an amount from 30 to 45 mol, based on 1 mol of anhydroglucose unit of the cellulose. The amount of cellulose in the starting slurry of cellulose in the solvent/water mixture is preferably within the range of from 1 to 14 weight %, more preferably from 3 to 12 weight %, and most preferably from 4 to 10 weight %, each based on the total weight of cellulose and solvent/water mixture.

According to the preferred slurry method, the alkalizing step (a) is typically conducted at a temperature within the range of from 10 to 40 °C, preferably from 15 to 40 °C, more preferably from 15 to 30 °C, even more preferably from 18 to 25 °C, and most preferably at about 20 °C. Typical reaction times for the alkalization step range from 15 to 120 min, preferably from 40 to 100 min, and more preferably from 50 to 80 min depending on the reaction temperature. In one embodiment the alkalizing step is conducted at about 20 °C for 50 to 70 min, preferably for 60 min.

In the carboxymethylation step (b) the monohaloacetic acid or a salt thereof, preferably the sodium salt, can be added neat or as a solution, preferably as an aqueous solution or as a solution in water and isopropyl alcohol and optionally methanol. The carboxymethylation step is typically conducted at a temperature within the range of from 40 to 100 °C, preferably from 50 to 90 °C, more preferably from 60 to 80 °C, and most preferably at about 70 °C. In preferred embodiments the monohaloacetic acid is already added to the reaction mixture before the carboxymethylation temperature is reached; more preferably the monohaloacetic acid is already added before the heating-up phase begins or within the first minutes of the heating-up phase, generally at a temperature which is described above for the alkalizing step, e.g. at from 15 to 40 °C. The early addition of the monohaloacetic acid at lower temperatures may avoid an undesired degradation of the cellulose (resulting in a decrease of viscosity) which may occur at the higher temperatures in absence of monohaloacetic acid. After the desired temperature of the carboxymethylation step (carboxymethylation temperature) as mentioned before is reached, the carboxymethylation temperature is typically held for a period of from 0 to 180 min, preferably from 20 to 140 min.

The product obtained from the carboxymethylation step, i.e. the etherification, is the sodium or potassium salt of carboxymethyl cellulose depending on which alkalizing agent was employed. According to a preferred embodiment the CMC salt is neutralized by adding acid, preferably an organic acid such as acetic acid or formic acid, more preferably acetic acid. Herein “neutralizing” means adjusting the pH value to a value of from 6 to 9, preferably 7 to 8. The CMC is then separated from the reaction mixture and purified, if necessary, depending on the intended end-use, and dried. Purification is performed according to standard methods well-known to the person skilled in the art. For example, the CMC can be washed with organic solvents including mixtures of organic solvents and solvent(s)/water mixtures, such as methanol, acetone, methanol/water mixtures, acetone/methanol mixtures, and methanol/isopropyl alcohol/water mixtures.

The outstanding property of the CMCs according to the present invention is their ability to form highly viscous aqueous solutions or gels having a low turbidity in combination with a low to moderate degree of substitution of the cellulose. Furthermore, the CMCs according to the present invention having a DS below 0.5 such as a DS between 0.4-0.5 are also biodegradable contrary to the current commercially available CMCs.

It has been found that the use of KOH as alkalizing agent in the present process results in CMCs with even superior gel-forming properties (higher viscosity and clarity) as compared to the use of NaOH. The improved gel-forming character of the CMC is maintained even if the K⁺ ions in the produced CMC have been exchanged by Na⁺ ions in a subsequent step. K⁺ ions in the produced CMC can be exchanged by Na⁺ ions after separating the CMC from the reaction mixture by, for example, washing it extensively with methanol comprising about 20 weight percent of a saturated aqueous sodium chloride solution. After the exchange of the K⁺ ions by Nat ions the CMC can be purified according to known procedures, for example as described above or in the examples below.

The CMC's according to the present invention, wherein the carboxymethylcellulose (CMC) has a degree of substitution (DS) equal to or below 0.6 and has a turbidity equal to or below 10 NTU, measured as a 2 weight % aqueous solution according to USEPA method 180.1 have been shown in the examples to be very useful as a coating agent for a battery electrode such as a lithium ion battery electrode, preferably a secondary battery electrode. In one aspect, the battery electrode is a cathode or an anode.

The compositions according to the present invention may further comprise graphite, silicone-based materials, carbon black, and polymer latex. Preferably, the amount present in the composition of carbon black is up to 3%, graphite/hard carbon is 40-60%, latex is 1-2%, silicon and silicone-based materials is 0.5-10%.

In an embodiment, polymer latex is selected from the group consisting of styrene-butadiene rubber (SBR), nitrile-butadiene rubber, methyl methacrylate-butadiene rubber, chloroprene rubber, carboxy modified styrene-butadiene rubber or mixtures thereof, preferably the polymer latex is (styrene-butadiene-rubber)-latex (SBR).

In an embodiment, the composition according to the present invention may further comprise silicone, and/or Carbon Nanotubes (CNT) and/or graphene and/or graphyne. Preferably the amount of CNT and graphyne is below 1%.

When an aqueous solution of CMC is prepared, gel particles derived from the CMC may remain as an unsolved substance in the aqueous solution. A mechanical dry or wet pulverization process for the CMC can reduce the size of the gel particles in the aqueous solution, however, the result may still be separation of a coating or pinholes on the electrode.

It has surprisingly been found that the compositions as disclosed herein have a very low amount of gel particles, such as a number of gel particles equal to or below 100/5 cm×5 cm, more preferably equal to or below 50/5 cm×5 cm, more preferably equal to or below 30/5 cm×5 cm, more preferably equal to or below 20/5 cm×5 cm, more preferably equal to or below 10/cm², most preferably equal to or below 5/5 cm×5 cm.

In an embodiment, disclosed herein is a process of preparing a composition according to the present invention, comprising the steps of:
a. Preparing a homogenous dry mixture of graphite, carbon black and optionally silicone
b. Mixing a solution of carboxymethylcellulose (CMC) with 50% of the homogeneous mixture of graphite, carbon black and optionally silicone prepared in step a),
c. Adding water to the mixture obtained in step b),
d. Adding the remaining 50% of the dry mixture of graphite, carbon black and optionally silicone prepared in step a) to the mixture obtained in step c),
e. Adding water to the mixture obtained in step d),
f. Adding polymer latex to the mixture obtained in step e).

Disclosed herein is further a battery electrode, wherein the electrode is coated with a composition as disclosed herein. Disclosed herein is further a lithium-ion battery electrode, such as a secondary battery electrode coated with a composition as disclosed herein. In an embodiment, the electrode is an anode. In a further embodiment, the electrode is a cathode. Disclosed herein is also a battery comprising a battery electrode as disclosed herein.

### EXAMPLES

The following examples are provided for illustrative purposes only and are not intended to limit the scope of the claims that follow. Unless otherwise indicated, all parts and percentages are by weight.

### Example 1

### Cellulose Starting Material

In all of the examples, 129.7 g of dry cellulose (corresponds to 0.8 mol anhydroglucose units (AGU)) were used together with varying amounts of isopropyl alcohol (IPA), methanol (MeOH), water, NaOH or KOH, and monochloroacetic acid (MCA) as indicated in the Table. MCA was added as a 80% solution in water.

First, the cellulose powder was introduced into a dry 3 litre laboratory reactor and then, the solvent mixture of isopropyl alcohol, methanol and water was added under a nitrogen atmosphere. NaOH (as prills) or KOH (as prills) were added under stirring at a temperature of 20 °C, stirring was continued for 15 minutes after which hydrogen peroxide was added in a concentration of 3% in water (examples D-H); stirring continued at 20 °C for a total of 60 min. Afterwards, the reaction mixture was heated up to 70 °C within 40 min and the monochloroacetic acid was added as a 80 weight % aqueous solution during the first minutes of the heating-up phase. The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 L of an isopropanol/methanol/water mixture (isopropanol/methanol/water weight ratio of 5:3:2) until no chloride ions were detected in the filtrate. This was followed by one final washing step with pure methanol. The washed samples were dried overnight in the drying cabinet at 55 °C and then milled in a laboratory mill.

The degree of substitution of the CMCs obtained was determined as described in the general part of the specification. 2 weight % solutions of the CMC samples were also prepared, and their viscosity, turbidity and transmission were determined as described in the general part of the specification. The results are given in the below Table 1 and Table 2.

TABLE 1

| | IPA¹ | H₂O₂ | MeOH¹ | H₂O¹ | NaOH | MCA | | | | | |
|---|---|---|---|---|---|---|---|---|---|---|---|
| | [mol/ | [mol/ | [mol/ | [mol/ | [mol/ | [mol/ | NaOH/ | | | | |
| | mol | mol | mol | mol | mol | mol | MCA | | Viscosity | Turbidity | Transmission |
| Sample | AGU] | AGU] | AGU] | AGU] | AGU] | AGU] | ratio | DS² | [mPa · s] | [NTU] | [%] |
| (D)-533 | 38.28 | 0.014 | 4.08 | 14.89 | 4.2 | 0.7 | 6.1 | 0.4 | 2440 | 3 | 97 |
| (E)-541 | 38.28 | 0.014 | 4.08 | 14.73 | 4.2 | 0.6 | 6.1 | 0.34 | 1800 | 3 | 96 |
| (F)-531 | 34.21 | 0.165 | 3.53 | 15.19 | 3.0 | 0.6 | 5 | 0.33 | 18 | 5 | 94 |
| (G)-012 | 34.61 | 0.33 | 3.54 | 15.19 | 3.2 | 0.6 | 5.3 | 0.33 | 7.5 | 8 | 89 |
| (H)-544 | 35.23 | 0.165 | 3.55 | 11.88 | 3.0 | 1.0 | 3 | 0.6 | 8 | 2 | 97 |

¹amounts used in the alkalizing step
²degree of substitution

TABLE 2

| | IPA¹ | H₂O₂ | MeOH¹ | H₂O¹ | NaOH | MCA | | | | | | |
|---|---|---|---|---|---|---|---|---|---|---|---|---|
| | [mol/ | [mol/ | [mol/ | [mol/ | [mol/ | [mol/ | NaOH/ | | | | | |
| | mol | mol | mol | mol | mol | mol | MCA | | Viscosity | Turbidity | Transmission | Gel |
| Sample | AGU] | AGU] | AGU] | AGU] | AGU] | AGU] | ratio | DS² | [mPa · s] | [NTU] | [%] | particles |
| −720 | 37.6 | 0.22 | 4.1 | 15.9 | 4.6 | 0.9 | 5.1 | 0.46 | 11800 | 2 | 98 | 25 |
| −704 | 37.3 | 0.55 | 4.1 | 16.5 | 4 | 0.7 | 5.7 | 0.38 | 3576 | 4 | 99 | 46 |

Two of the above CMC syntheses, samples D and E were conducted with water concentrations below 15 mol/mol AGU and high concentrations of sodium hydroxide (>4 mol/mol AGU) resulting in CMC having a DS below 0.5. The solutions from these CMCs show a very low turbidity and high transmittance. The synthesis was conducted as described on page 11 of WO 2011/120533 except that the amounts of reactants and solvents according to the table 1 above was used. Sample D has a DS of 0.4 and a turbidity of 3.1 NTU which is a lower turbidity than the CMC of example 5 from WO 2011/120533 which has a DS of 0.4 and a turbidity of 14 NTU. Sample E has a DS of 0.34 and a turbidity of 3 NTU which is a lower turbidity than the CMC of example 18 from WO 2011/120533 which has a DS of 0.36 and a turbidity of 10 NTU.

The turbidity of the samples of WO 2011/120533 were measured at a lower concentration (1%) than the turbidity of samples D and E which were measured at 2%. The higher the concentration the higher is the turbidity of the solution. Nevertheless, even at 2% concentration samples D and E show a lower turbidity than the prior art.

Sample H is a CMC with a DS of 0.6 being synthesized with high concentrations of alkali but with water concentration <15 mol/mol AGU.

### COMPARATIVE EXAMPLES

### Comparative Example 1

CMCs 529 and 538 were prepared as described above for samples D and E.

### CMC 720

129.7 g of dry wood cellulose (corresponds to 0.8 mol anhydroglucose units (AGU)) were used together with 1806 g of isopropyl alcohol, 104.59 g of methanol (MeOH), 199.5 g of water, 147.19 g of NaOH, 6 g of a 3 wt-% solution of hydrogen peroxide and 85.5 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards hydrogen peroxide was added and the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

### CMC 704

129.7 g of dry cotton cellulose (corresponds to 0.8 mol anhydroglucose units (AGU)) were used together with 1793.3 g of isopropyl alcohol, 104.45 g of methanol (MeOH), 202 g of water, 128 g of NaOH, 15 g of a 3 wt-% solution of hydrogen peroxide and 66.4 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards hydrogen peroxide was added and the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

### CMC 538

129.7 g of dry cotton cellulose (corresponds to 0.8 mol anhydroglucose units (AGU)) were used together with 1818.9 g of isopropyl alcohol, 104.73 g of methanol (MeOH), 183 g of water, 147.2 g of NaOH, 11 g of a 3 wt-% solution of hydrogen peroxide and 85.48 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards hydrogen peroxide was added and the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

### CMC 529

129.7 g of dry cotton cellulose (corresponds to 0.8 mol anhydroglucose units (AGU)) were used together with 1818.9 g of isopropyl alcohol, 104.73 g of methanol (MeOH), 181 g of water, 134.4 g of NaOH, 13 g of a 3 wt-% solution of hydrogen peroxide and 85.48 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards hydrogen peroxide was added and the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

The CMC's 480, 474, 511 were prepared as follows:

### CMC 480

129.7 g of dry cotton cellulose (corresponds to 0.8 mol anhydroglucose units (AGU)) were used together with 1818.9 g of isopropyl alcohol, 104.73 g of methanol (MeOH), 191 g of water, 134.4 g of NaOH, 3 g of a 3 wt-% solution of hydrogen peroxide and 188.76 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards hydrogen peroxide was added and the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 L of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

### CMC 474

129.7 g of dry cotton cellulose (corresponds to 0.8 mol anhydroglucose units (AGU)) were used together with 1793.3 g of isopropyl alcohol, 104.5 g methanol (MeOH), 220 g water, 73.6 of NaOH, and 103.82 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards, the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

### CMC 511

129.7 g of dry cotton cellulose (corresponds to 0.8 mol anhydroglucose units (AGU)) were used together with 1780.6 g of isopropyl alcohol, 104.3 g of methanol (MeOH), 222 g of water, 70.4 g of NaOH, 11 g of a 3 wt-% solution of hydrogen peroxide and 89.66 g of monochloroacetic acid solution (80%) (MCA). First, the cellulose powder was introduced into a dry 3-liter laboratory reactor and then, the solvent mixture of isopropyl alcohol, methanol and water was added under a nitrogen atmosphere. NaOH (as prills) was added under stirring at a temperature of 20 °C and stirring was continued at 20 °C for a total of 60 min. Afterwards hydrogen peroxide was added and the reaction mixture was heated up to 70 °C within 40 min Then the monochloroacetic acid was added as a 80 weight % aqueous solution.

The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of a methanol/water mixture (methanol/water weight ratio of 4:1) until no chloride ions were detected in the filtrate. This was followed by one final washing step with pure methanol. The washed samples were dried overnight in the drying cabinet at 55 °C and then milled in a laboratory mill.

### Determination of the Number of Gel Particles

In order to determine the number of gel particles as described herein, gels are observed via a wet coating method by coating CMC solution on surface treated PET film and then do the counting in a 5*5 square area with repeat tests. The CMC solutions were made under the following detailed process: Around 1.000 grams CMC powders were dispersed on the surface of aluminium foil in the automatic moisture testing machine (moisture analyzer MA37 from Sartorius AG, Germany). The moisture testing is run using the automatic testing process at a temperature of 130 °C. The CMC solution is prepared by adding 135.5 grams of deionized water into the metal cup of a high-speed mixer and mix at a speed at 300 rpm. Add around 1.5 grams CMC powders to the water. After all the powders are dispersed in the water, increase the mixing speed to 4000 rpm and keep the mixing for 30 minutes. A clear aqueous solution is obtained with many bubbles inside due to the high-speed mixing. The prepared CMC solution should be stored at room temperature for one day to remove the bubbles off the solution. Then A4 size papers are prepared with 5×5 cm² squares and covered by the same size PET film. Several drops of prepared CMC solution are sucked from the middle/bottom area of CMC solution bottle and then released on the left side of the PET film in close square areas, and followed by casting from left side to the right side using knife blade with 100 micro meter gap. The wet coating of CMC solution on PET film was observed under LED light, and the bright spots were identified as insoluble gels. The gel number was calculated from each square and recorded by two persons to reduce the manual observation error. One trick to help the observation clearly is to add one piece of glass between the A4 paper background and PET film which will make it very clear showing with bright spots for the gels. CMC 480 presents 4 gel particles/5 cm×5 cm; CMC 474 presents 17 gel particles/5 cm×5 cm; CMC 529 presents 72 gel particles/5 cm×5 cm; CMC 538 presents 72 gel particles/5 cm×5 cm; and CMC 511 presents 17 gel particles/5 cm×5 cm.

### Manufacturing of the Slurry

A high-speed mixer with dissolver disk is positioned into an ice cooled metal beaker which is filled with 30.44 g of a 2% solution of CMC. At a mixing speed of 500/see, 50% of a homogeneous dry mix of 46.75 g graphite (Mechano Cap 1P1) and 0.73 g conductive carbon black (C-Nergy Super C 65) is dispersed over a time of 5 min into the liquid. Then 5.59 g of water is added. In the next step the other 50% of the homogeneous mixture of graphite and carbon black are added, the mixing speed is raised to 2000/min. After 40 min of stirring the speed is decreased down to 500/min and further 5.59 g of water are added. At the end 1.01 g of SBR-latex BM-451B (producer Zeon) is added. The slurry is stirred for further 30 sec and the mix is completed. In total the batch has a weight of 90.11 g and a solid content of 54.05%. To remove air bubbles a pressure of 100 mbar is applied for 5 min. The tables below give the calculated average.

### Manufacturing of the Electrodes for the Adhesion Strength Test

A 10 μm thin copper foil was coated with the graphite slurry using a 200 μm doctor blade. The drying of the coated electrode is done for 30 min at 45 °C in a drying cabinet. The coated copper film was fixed on a solid support. In a pull-off test with a Texture Analyser XT Plus the tensile adhesion strength was measured (stamp diameter 10 mm, stamp speed before touching the sample 0.3 mm/s, compacting pressure 10 s with 6 kg (=0.75 N/mm²), removal speed of the stamp 3 mm/s). If the surface of the coating is not fully flat, the stamp (covered with a double-sided adhesive tape) can get only a certain percentage out of the surface of the coating. This is considered into the calculation. All different formulations have been measured 12 times.

The degree of substitution of the CMCs used was determined as described in the general part of the specification. 2 weight % solutions of the CMC samples were also prepared, and their turbidity were determined as described in the general part of the specification. The results are given in the below tables.

Two series of tests were performed: one series of formulation as described below (Table 3) and one series of formulation which did not contain any SBR-latex (Table 3). No clear effect is seen in Table 3. The second series was intended to visualize the effect of the CMC on the adhesion strength clearer as the SBR also contributes to the adhesion strength (Table 4).

TABLE 3

| | | | Adhesion | Turbidity |
|---|---|---|---|---|
| | DS (CM) | ¹Viscosity | strength | [NTU] |
| Sample number | of CMC | (1%) | (N/mm²) | of CMC |
| 480 (comparison) | 1.21 | 2444 | 121 | 3.5 (2%) 1.7 |
| | | | | NTU (1%) |
| 474 (comparison) | 0.88 | 2160 | 117 | 2.7 NTU |
| | | | | (1%) |
| 511 (comparison) | 0.75 | 2460 | 128 | 1.8 (1%) |
| 529 | 0.53 | 2400 | 134 | 2.7 (1%) |
| 538 | 0.47 | 2220 | 127 | 3.1 (1%) |

¹viscosity determination method: measured as 1% solution with Brookfield LVT at 25 °C with 30 rpm and spindle 3.

TABLE 4

| Sample number | | | Adhesion | Turbidity |
|---|---|---|---|---|
| (sample with | DS (CM) | ¹Viscosity | strength | [NTU] |
| SBR-latex) | of CMC | (1%) | (N/mm²) | of CMC |
| 480 (comparison) | 1.21 | 2444 | 91 | 3.5 (2%) 1.7 |
| | | | | NTU (1%) |
| 474 (comparison) | 0.88 | 2160 | 97 | 2.7 NTU |
| | | | | (1%) |
| 511 (comparison) | 0.75 | 2460 | 96 | 1.8 (1%) |
| 529 | 0.53 | 2400 | 107 | 2.7 (1%) |
| 538 | 0.47 | 2220 | 112 | 3.1 (1%) |

¹viscosity determination method: measured as 1% solution with Brookfield LVT at 25 °C with 30 rpm and spindle 3.

### Manufacturing of the Electrodes for the Cell Assembling and for the Battery Test

A 10 μm thin copper foil was coated with the graphite slurry using a roll-to-roll coating machine (Mathis KTF-S) with a doctor blade unit. The machine contains two drying units with 1 m length of each. The coating parameters were: coating speed: 0.2 m/min, wet film thickness about 100 μm, drying at 30 °C at the beginning and 50 °C at the end of the drying channel.

### Cell Assembling

Pouch cells of each 54×54 mm² were produced. The anode as well as the cathode were single side coated. The cathode consists of the active material NMC622 with adapted loading. A ceramic coated polyolefin non-woven (Separion®) was used as a separator. Before assembling the electrodes and the separator were dried in a vacuum drying cabinet over night at 130 °C. The assembling of the pouch cells was done in a dry room with a dew point of about −70 °C. A pure Lithium-sheet was used as counter electrode (Alfa Aesar 99.99%). 1:1 EC/DMC+3% VC with 1 M LiPF₆ as conductive salt was used as electrolyte for charging the cells.

(EC: ethylene carbonate, DMC: dimethyl carbonate, VC: vinylene carbonate)

### Cell Tests and Results

All pouch cells were tested on capacity, aging behavior during cycling and stability in a cell tester (Basytec CTS) under identical conditions. After four formation cycles at a C-C-rate C/20, a C-rate test with 10 cycles of C/2, 1C, 2C, 3C und 5C and again 1C was performed. Subsequently an aging of cells was determined at a C-rate of 3C.

The loading happened with CC/CV at a voltage between 3.0 and 4.2 Volt. Below the discharge rate of 1C the charging and discharging profile had a symmetric profile, in all other cases the charging happened with 1C.

The CV-step at 4.2 V was kept until the charging current decreased to C/20. The capacity of the NMC622-cathode was used for the determination of the C-rate. The theoretical capacity was estimated to be 175 mAh/g.

A standard method for evaluation is the quantification of the decrease of the specific discharge capacity as a function of the number of charging/discharging cycles. The following Table 4 shows the slope of the decrease of the specific discharge capacity over cycling at 3C. Four different substitution degrees were tested. The evaluation contained all battery samples which passed at least 600 cycles showing only little deviations from a constant decrease in specific discharge capacity. From 20 samples 17 fulfilled this criterion. The slope was evaluated between cycle 120 and cycle 600. At cycle 120 all specific discharge capacities were set to 100% (before cycle 120 the C-rate test was performed).

It can be concluded from the below Table 5 that the best performing CMC is the one having a DS of 0.47 and a NTU below 10.

TABLE 5

| | | | Average value at | Turbidity [NTU] |
|---|---|---|---|---|
| Sample No. | DS | Slope | this DS | of CMC |
| 1 | 0.47 | −0.0090 | −0.0094 | 3.1 |
| 2 | | −0.0085 | | |
| 3 | | −0.0090 | | |
| 4 | | −0.0108 | | |
| 5 | | −0.0097 | | |
| 6 | 0.75 | −0.0191 | −0.0208 | |
| 7 | | −0.0196 | | |
| 8 | | −0.0193 | | |
| 9 | | −0.0250 | | |
| 12 | 0.88 | −0.0212 | −0.0235 | |
| 13 | | −0.0245 | | |
| 14 | | −0.0233 | | |
| 15 | | −0.0251 | | |
| 16 | 1.21 | −0.0234 | −0.0239 | |
| 17 | | −0.0197 | | |
| 18 | | −0.0251 | | |
| 19 | | −0.0275 | | |

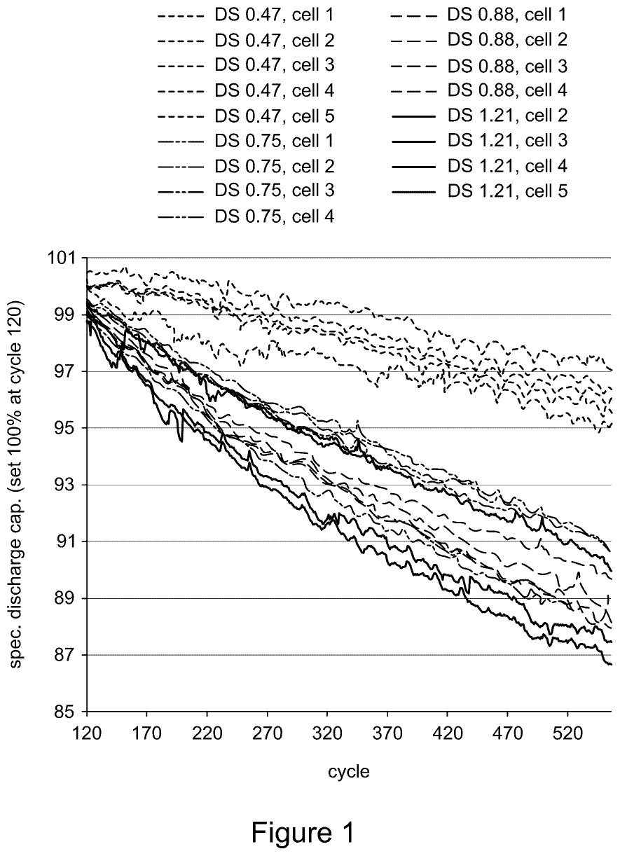

FIG. 1 contains the curves which were evaluated for the determination of the slopes of the indicated CMC's.

Very good battery cells are also characterized in low differences between several individual cells as well as in a low “noise” (scattering of the specific discharge capacity of an individual cell as a function of the cycle). Both properties are derived from a more homogeneous electrode coating. A more homogeneous electrode coating results normally in a lower fluctuation of the loading capacity as a function of the cycle.

The differences between individual cells as well as the “noise” of an individual cell was evaluated in the following way:

The specific discharge capacity of every tested cell was noted at every hundred cycles (at 100, 200, 300, 400 . . . , etc. cycles). At a given cycle the mean value between all (up to five) cells (of one individual DS) was evaluated and its standard deviation was calculated (see Table 6).

TABLE 6

| | DS 0.47 | | DS 0.75 | | DS 0.88 | | DS 1.21 | |
|---|---|---|---|---|---|---|---|---|
| | Mean | | Mean | | Mean | | Mean | |
| | value of | | value of | | value of | | value of | |
| | discharge | Standard | discharge | Standard | discharge | Standard | discharge | Standard |
| Cycle | capacity | deviation | capacity | deviation | capacity | deviation | capacity | deviation |
| 100 | 128.52 | 1.54 | 127.65 | 2.13 | 117.56 | 14.46 | 123.31 | 1.76 |
| 200 | 123.93 | 0.84 | 123.60 | 2.21 | 113.72 | 14.40 | 117.77 | 1.97 |
| 300 | 122.71 | 0.81 | 120.61 | 2.56 | 110.91 | 14.31 | 114.56 | 1.77 |
| 400 | 121.30 | 0.74 | 117.90 | 2.57 | 108.20 | 14.31 | 110.12 | 5.17 |
| 500 | 120.42 | 0.89 | 114.58 | 2.00 | 106.01 | 14.16 | 107.64 | 5.45 |
| 600 | 119.13 | 0.90 | 112.51 | 2.11 | 104.16 | 14.68 | 108.97 | 2.49 |
| 700 | 118.06 | 0.90 | 111.07 | 2.00 | 102.20 | 14.90 | 108.05 | 2.95 |
| 800 | 117.18 | 0.94 | 109.43 | 2.29 | 95.47 | 12.33 | 106.54 | 3.01 |
| 900 | 116.02 | 0.98 | 106.94 | 1.63 | | | 89.43 | 19.05 |
| 1000 | 114.72 | 0.98 | 105.36 | 1.73 | | | 101.18 | 0.55 |
| 1100 | 114.04 | 1.00 | | | | | | |

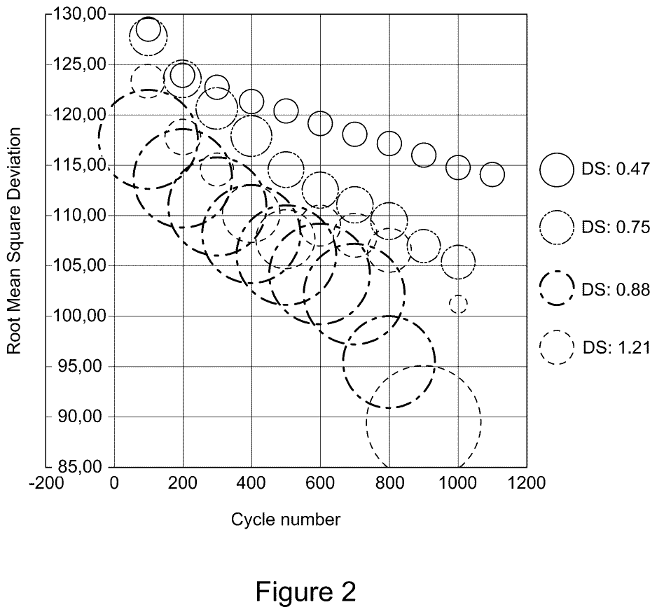

FIG. 2 contains the mean value of discharge capacity as a function of the cycle number. The diameter of the bubble indicates the standard deviation of all the measured values of discharge capacity. A DS of 0.47 shows very reproducible values of low standard deviations, where a DS of 0.75 and 0.88 shows systematically growing standard deviations. At DS of 1.21 the standard deviation is changing in a not systematically order.

### Comparative Example 2

Sample 002 is the reproduction of example 1 (comparative sample 1) of US20220020993A1 and has a DS of 0.65 like example 1, and a turbidity of 4.0 NTU as 1 wt % solution. The viscosity of this comparative sample 1 is 3060 mPa·s, which is a little bit lower than the viscosity of example 1 in US20220020993A1 where the viscosity is 4700 mPa·s. However, no cellulose grade was disclosed in example 1 in US20220020993A1 which has an influence on the viscosity. Sample 003 (OPE-22-01-AL-003) is the reproduction of comparative example 1 US20220020993A1 and has a comparable DS of 0.26 vs 0.3 and a comparable viscosity of 110 mPa·s vs 150 mPa·s.

As it can be seen from below Table 7, sample 003 has a very high turbidity and low solubility as expected (1549 NTU).

TABLE 7

| | | | | | | | | | | | |
|---|---|---|---|---|---|---|---|---|---|---|---|
| | IPA¹ | H₂O₂ | MeOH¹ | H₂O¹ | NaOH | MCA | | | | | |
| | [mol/ | [mol/ | [mol/ | [mol/ | [mol/ | [mol/ | NaOH/ | | | | |
| | mol | mol | mol | mol | mol | mol | MCA | | Viscosity | Turbidity | Transmission |
| Sample | AGU] | AGU] | AGU] | AGU] | AGU] | AGU] | ratio | DS² | [mPa · s] | [NTU] ** | [%] |

| | | | | | | | | |
|---|---|---|---|---|---|---|---|---|
| 002 | 1337.7 | 1.62 | 0.86 | 1.62 | 0.65 | 3060 | 4.0 | 97.3 |
| 003 | 1337.7 | 0.80 | 0.40 | 0.80 | 0.26 | 110 | 1549 | 5.3 |

** 1 wt % solution

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in biochemistry and biotechnology or related fields are intended to be within the scope of the following claims.

1. A composition comprising carboxymethylcellulose (CMC), wherein the carboxymethylcellulose (CMC) has a degree of substitution (DS) equal to or below 0.6 and has a turbidity equal to or below 10 NTU, measured as a 2 weight % aqueous solution according to USEPA method 180.1.

2. The composition according to claim 1, wherein said composition further comprises graphite, carbon black, and polymer latex.

3. The composition according to claim 1, wherein the carboxymethylcellulose (CMC) has a turbidity in the range of 1-10 NTU, more preferably in the range of 1.5-8 NTU, more preferably in the range of 2-6 NTU, more preferably in the range of 2-5 NTU, most preferably in the range of 2-4 NTU, measured as a 2 weight % aqueous solution according to USEPA method 180.1.

4. The composition according to claim 1, wherein the carboxymethylcellulose (CMC) has a turbidity equal to or below 8 NTU, preferably equal to or below 7 NTU, more preferably equal to or below 6 NTU, more preferably equal to or below 5 NTU, most preferably equal to or below 4 NTU, measured as a 2 weight % aqueous solution according to USEPA method 180.1.

5. The composition according to claim 1, wherein said carboxymethylcellulose (CMC) has a degree of substitution (DS) equal to or below 0.55, more preferably equal to or below 0.5, more preferably equal to or below 0.45, most preferably equal to or below 0.4.

6. The composition according to claim 1, wherein the polymer latex is selected from the group consisting of styrene-butadiene rubber (SBR), nitrile-butadiene rubber, methyl methacrylate-butadiene rubber, chloroprene rubber, carboxy modified styrene-butadiene rubber or mixtures thereof.

7. The composition according to claim 6, wherein the polymer latex is (styrene-butadiene-rubber)-latex (SBR).

8. The composition according to claim 1, wherein said composition further comprises silicone, silicon suboxide (SiO), silicon carbide (SiC), delivered as micro or nanomaterials, or Carbon Nanotubes (CNT) or a combination of the silicone, silicon suboxide, Carbon Nanotubes or graphene or graphyne or any combination of the silicone, silicon suboxide, Carbon Nanotubes, graphene and graphyne.

9. The composition according to claim 1, wherein the number of gel particles is equal to or below 100/5 cm×5 cm, more preferably equal to or below 50/5 cm×5 cm, more preferably equal to or below 30/5 cm×5 cm, more preferably equal to or below 20/5 cm×5 cm, more preferably equal to or below 10/5 cm×5 cm, most preferably equal to or below 5/5 cm×5 cm.

10. A method of using a composition as a coating agent for a battery electrode, wherein said composition comprises carboxymethylcellulose (CMC) having a degree of substitution (DS) equal to or below 0.6 and has a turbidity equal to or below 10 NTU, measured as a 2 weight % aqueous solution according to USEPA method 180.1.

11. (canceled)

12. The method according to claim 10, wherein the battery electrode is a lithium ion battery electrode.

13. The method according to claim 10, wherein the battery electrode is a secondary battery electrode.

14. The method according to claim 10, wherein the electrode is an anode.

15. The method according to claim 10, wherein the electrode is a cathode.

16. A battery electrode, wherein the electrode is coated with a composition, wherein said composition comprises carboxymethylcellulose (CMC) having a degree of substitution (DS) equal to or below 0.6 and has a turbidity equal to or below 10 NTU, measured as a 2 weight % aqueous solution according to USEPA method 180.1.

17. (canceled)

18. (canceled)

19. (canceled)

20. (canceled)

21. (canceled)

22. (canceled)

23. A process of preparing a composition as defined in claim 1 comprising the steps of:
a. preparing a homogenous dry mixture of graphite, carbon black and optionally silicone;
b. mixing a solution of carboxymethylcellulose (CMC) with 50% of the homogeneous mixture of graphite, carbon black and optionally silicone prepared in step a);
c. adding water to the mixture obtained in step b);
d. adding the remaining 50% of the dry mixture of graphite, carbon black and optionally silicone prepared in step a) to the mixture obtained in step c);
e. adding water to the mixture obtained in step d); and
f. adding polymer latex to the mixture obtained in step e).

24. A carboxymethylcellulose (CMC) having a degree of substitution (DS) equal to or below 0.6 and having a turbidity equal to or below 10 NTU, measured as a 2 weight % aqueous solution according to USEPA method 180.1.

25. (canceled)

26. (canceled)

27. The carboxymethylcellulose (CMC) according to claim 24, which CMC has a degree of substitution (DS) equal to or below 0.55, more preferably equal to or below 0.5, more preferably equal to or below 0.45, most preferably equal to or below 0.4.

28. The method according to claim 10, wherein the battery electrode is a sodium-ion battery electrode.

29. The battery electrode according to any one of claims 16-17, wherein the battery electrode is a sodium-ion battery electrode.
